(19) United States
(12) Patent Application Publication
(10) Pub. No.: US 2013/0107122 A1
(43) Pub. Date: May 2, 2013

(54) APPARATUS FOR CONTROLLING EXTERNAL DEVICE AND METHOD THEREOF

(71) Applicant: Sungchang HA, Suwon (KR)

(72) Inventor: Sungchang HA, Suwon (KR)

(21) Appl. No.: 13/437,693

(22) Filed: Apr. 2, 2012

(30) Foreign Application Priority Data
Nov. 1, 2011 (KR) 10-2011-0112930

(51) Int. Cl. H04N 5/44; H04N 5/445

(52) U.S. Cl. 348/563; 348/553; 348/E05.096; 348/E05.103

(57) ABSTRACT

An image display device including a communication unit configured to wirelessly or wiredly communicate with external devices; a display unit configured to display media content being reproduced on the image display device; and a controller configured to distinguish at least one external device that can be controlled to generate an effect of stimulating senses of a user watching the reproduced media content, and to control the distinguished external device to generate the effect of stimulating the senses of the user in accordance with effects occurring on the displayed media content.

### CROSS-REFERENCE TO A RELATED APPLICATION

Pursuant to 35 U.S.C. §119, this application claims the benefit of earlier filing date and right of priority to Korean Application No. 10-2011-0112930, filed in the Republic of Korea on Nov. 1, 2011, the contents of which is incorporated by reference herein in its entirety.

### BACKGROUND OF THE INVENTION

1. Field of the Invention

The present invention relates to image display device controlling at least one external device to generate an additional stimulating sense corresponding to particular content being displayed on the image display device.

2. Background of the Invention

3D movies and even 3D televisions are becoming more and more popular. Museums and public relation offices also now use 3D technology when showing documentaries, advertisements, etc. Many video game manufacturers are also now providing 3G games and other forms of entertainment. However, one problem with the 3D technology is that the stimulated effect occurs only via the eyes of the user watching the program.

### SUMMARY OF THE INVENTION

Accordingly, one object of the present invention is to address the above-noted and other problems with the related art.

Another object of the present invention is to distinguish and control one or more external devices to produce different sensations matching or being similar to effects occurring on a content being reproduced.

To achieve these and other advantages and in accordance with the purpose of this specification, as embodied and broadly described herein, the present invention provides in one aspect an image display device including a communication unit configured to wirelessly or wiredly communicate with external devices; a display unit configured to display media content being reproduced on the image display device; and a controller configured to distinguish at least one external device that can be controlled to generate an effect of stimulating senses of a user watching the reproduced media content, and to control the distinguished external device to generate the effect of stimulating the senses of the user in accordance with effects occurring on the displayed media content.

In another aspect, the present invention provides a method of controlling an image display device, and which includes allowing, via a communication unit of the image display device, wireless or wired communication with external devices; displaying, via a display unit of the image display device, media content being reproduced on the image display device; distinguishing, via a controller of the image display device, at least one external device that can be controlled to generate an effect of stimulating senses of a user watching the reproduced media content; and controlling, via the controller, the distinguished external device to generate the effect of stimulating the senses of the user in accordance with effects occurring on the displayed media content.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram illustrating an image display device according to an embodiment of the present invention;

FIG. 2 is a flowchart illustrating a method of controlling a device according to an embodiment of the present invention;

FIG. 3 is a flowchart illustrating a method of controlling at least one external device based on context information and meta data according to a first embodiment of the present invention;

FIG. 4 is an overview illustrating a method of controlling a device according to the first embodiment of the present invention;

FIG. 5 is an overview illustrating a channel of collecting meta data according to the first embodiment of the present invention;

FIG. 6 is a flowchart illustrating a method of collecting or generating meta data according to the first embodiment of the present invention;

FIG. 7 is an overview illustrating a method of displaying control information of an external device according to a second embodiment of the present invention;

FIG. 8 is an overview illustrating a method of displaying control information of an external device according to the second embodiment of the present invention;

FIG. 9 is an overview illustrating a method of displaying control information of an external device according to the second embodiment of the present invention;

FIG. 10 is an overview illustrating a method of displaying control information of an external device according to the second embodiment of the present invention;

FIG. 11 is an overview illustrating a method of displaying control information of an external device according to a third embodiment of the present invention; and

FIG. 12 is an overview illustrating the control scenario of an external device according to an embodiment of the present invention.

### DETAILED DESCRIPTION OF THE INVENTION

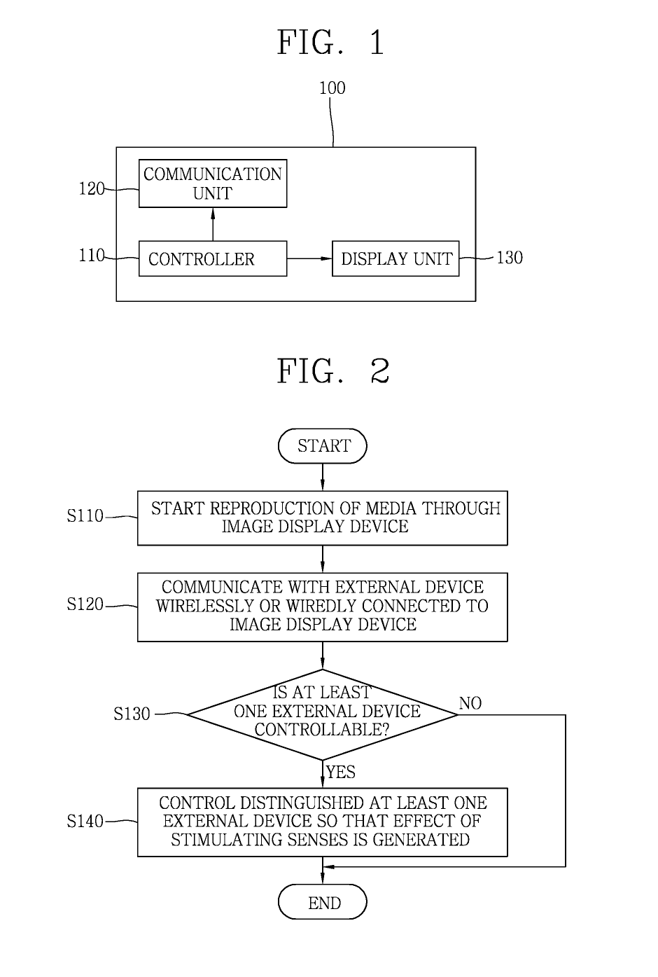

FIG. 1 is a block diagram illustrating an image display device 100 according to an embodiment of the present invention. As shown, the image display device 100 includes a controller 110, a communication unit 120, and a display unit 130.

In addition, the communication unit 120 can wirelessly or wiredly communicate with an external device. The image display device 100 can also control the external device to generate additional effects to stimulate the senses of a user watching the image display device 100. The image display device 100 can communicate with the external devices using suitable wired/wireless control protocols.

The connection between the image display device 100 and the external device can be via at least one of an optical fiber, a cable, a power line, a radio frequency (RF), and infrared rays. However, other connection methods may be applied to the embodiment disclosed in the present specification.

In addition, wired or wireless communication protocols for controlling the external devices are various. For example, Bluetooth, radio frequency identification (RFID), infrared data association (IrDA), ultra wideband (UWB), ZigBee, and wireless LAN (Bluetooth 802.11n) protocols can be used. In addition, wireless LAN (WLAN), Wi-Fi, wireless broadband (Wibr), world interoperability for microwave access (Wimax), and high speed downlink packet access (HSDPA) systems may be used as a wireless Internet technology.

In addition, a universal serial bus (USB) port, IEEE1394, high-definition multimedia interface (HDMI) port, display port (DP), wired/wireless headset port, external charger port, wired/wireless data port, memory card port, connection ports, audio input/output (I/O) port, video I/O port, and earphone port may be used as a port or interface. Also, X10, universal power line bus (UPB), INSTEON, Instabus, Z-Wave, BACnet, and LonWorks may be used as the control communication protocol. Other control communication protocols may also be used.

Further, the external device includes various apparatuses or devices that exist in the same space as the image display device 100. For example, the external device may be any illumination equipment, home appliance, mobile terminal, image device, sound device, etc. The controller 110 also performs various functions to stimulate the senses of the user(s) watching the image display device 100.

Further, the controller 110 can distinguish an external device that can be controlled and control the distinguished external device to generate the effect that stimulates the user's senses. In addition, the user's sense may be the sense of sight, smell, taste, hearing, a skin effect, the depths, internal organs, and equilibrium. In addition, the skin effect can be a sense of touch, sense of pressure, and sense of temperature on the skin.

Further, when one of the external devices is the illumination device (e.g., lights in a room), the controller 110 can first start the reproduction of the media and then turn off the illumination device when the content of the media is reproduced. Thus, the user can watch the content (e.g., movie, etc.) while feeling a cozy atmosphere. That is, the user can get the feeling of watching the media content in a theater. In addition, the user may visually sense that the reproduction of the media is started, because the illumination device is turned off.

The display unit 130 can also display various information items on a screen in addition to the media content. In addition, the display unit 130 can also display the control information of the external device on a portion of the image display device 100. For example, the control information of the external device can be displayed as a thumbnail.

Further, the display unit 130 may be included inside the image display device 100. However, the image display device 100 may transmit the image data corresponding to the media or the control information to a display apparatus existing outside the image display device 100. The external display apparatus then displays the media and/or control information.

Next, FIG. 2 is a flowchart illustrating a method of controlling a device according to an embodiment of the present invention. Referring to FIG. 2, the image display device 100 starts the reproduction of media (S110), and communicates with one or more external device wirelessly or wiredly connected to the image display device 100 (S120).

Then, the image display device 100 distinguishes one or more external devices that can be controlled in accordance with the reproduction of the media through the communication (S130). The image displaying device 100 then controls the distinguished external device(s) to generate an effect of stimulating the user's senses (S140). Of course, the user can include multiple users in the room. The image display device 100 then controls the external device(s) to stop generating the effect when the corresponding effect occurring in the reproduced media content is stopped, for example. If the image display device 100 determines no external devices exist (No in S130), the image display device 100 does not control the external devices.

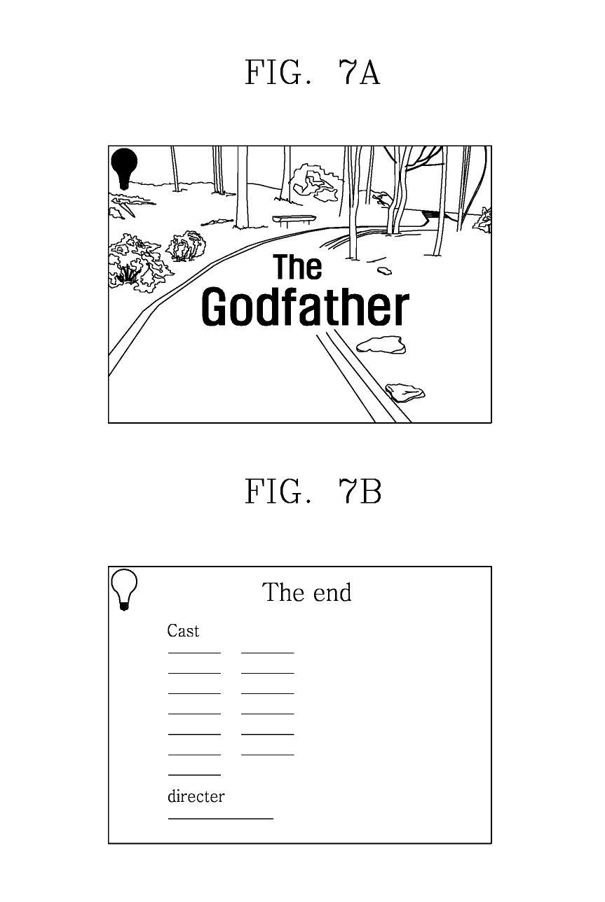

In addition, as discussed above, image display device 100 can display the control information of the external device on the screen of the image display device 100 (these features are discussed later with respect to FIGS. 7 to 9). In addition, the image display device 10 can also sense context information corresponding to the reproduced media, obtain meta data, etc. for controlling the external device, and then control the external device based on the context information and the meta data.

In addition, when obtaining the meta data, the image display device 100 can determine whether the meta data exists in an internal or external server of the media content, obtain the meta data from the internal or external server when the meta data exists, collect reference data used for generating the meta data from the internal or external server, and generate the meta data based on the collected reference data when the meta data does not exist.

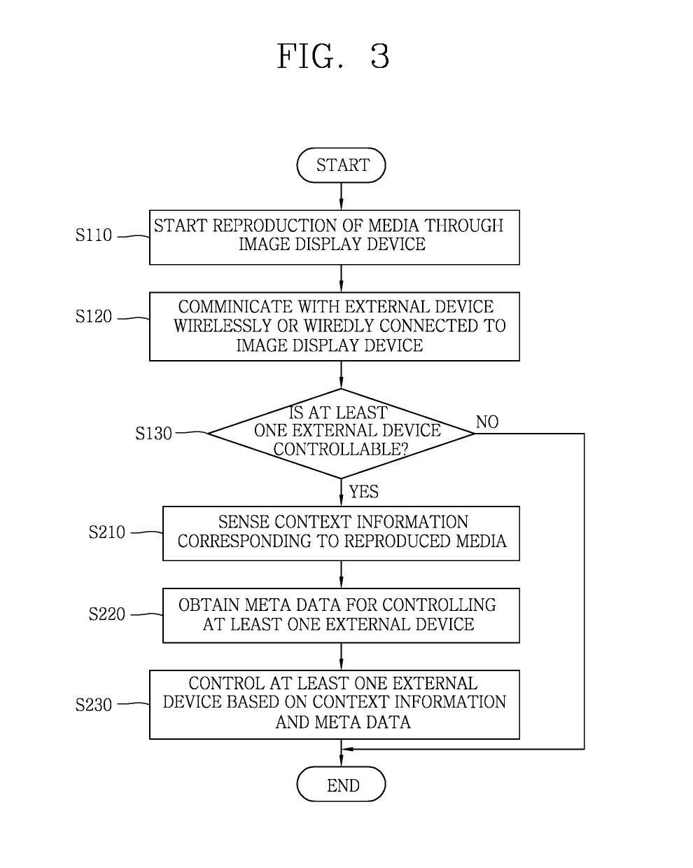

Next, FIGS. 3 to 6 illustrate controlling the external device(s) and obtaining the meta data based on the context information and the meta data. In more detail, FIG. 3 is a flowchart illustrating a method of controlling an external device based on context information and meta data according to a first embodiment of the present invention.

Referring to FIG. 3, the image displaying device 100 starts the reproduction of media content (S110), and wirelessly or wiredly communicates with the external device connected to the image display device 100 (S120). Then, the image display device 100 distinguishes one or more external devices that can be controlled in accordance with the reproduction of the media through the communication (S130). These steps are similar to the steps 110, 120 and 130 in FIG. 2, and thus the same reference numerals are being used.

Then, the image display device 100 senses context information corresponding to the reproduced media (S210), and obtains meta data for controlling the external device(s) (S220). The image display device 100 then controls control the distinguished external device based on the context information and the meta data (S230). The image display device 100 stops or doesn't control the external device when there are no controllable external devices (No in S130).

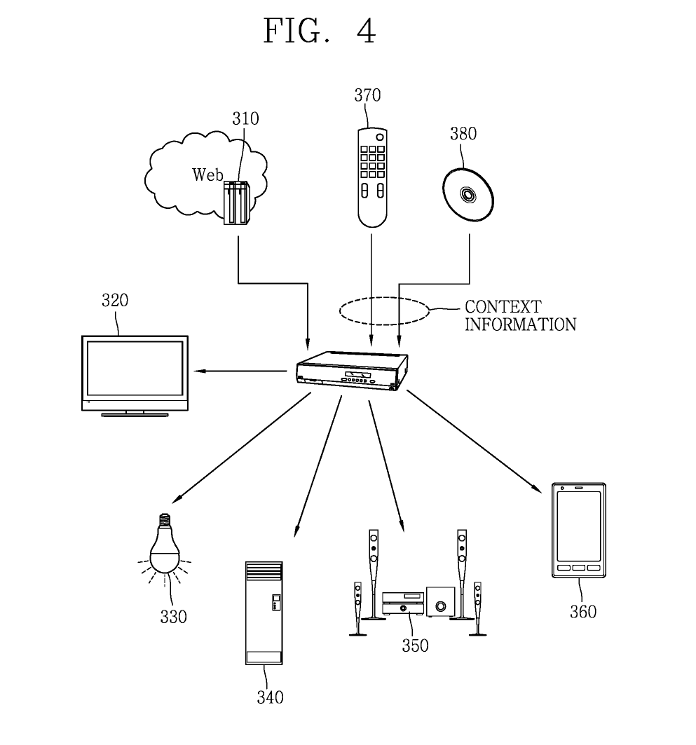

Next, FIG. 4 is an overview illustrating a method of controlling a device according to the first embodiment of the present invention. Referring to FIG. 4, the image display device 100 transmits an image signal corresponding to the media content to a display apparatus 320 wiredly or wirelessly connected to the image display device 100. The display apparatus 320 then displays and reproduces the media content.

In addition, the image display device 100 senses context information corresponding to the reproduced media. In particular, the context information includes, for example, information indicating that the reproduction of the media content has started, information on the time code of the media content, information on the event including the media content, etc.

For example, when the user of the image display device 100 operates a controller 370 (for example, a remote controller) of the image display device 100 to reproduce the media content, the context information can indicate that the reproduction of the media is started. In this instance, the image display device 100 senses the media is being reproduced based on the selection input received from the controller 370 and turns off illumination equipment 330 so that the user can comfortably and conveniently watch the media content.

In addition, the context information can be sensed through various paths. For example, the image display device 100 can sense the context information from media 380. When the context information is the time code of the media 380, the image display device 100 can control one or more external devices in the scene corresponding to a specific time code in the reproduction of the media 380. The image display device 100 can also sense the context information using various other methods.

In addition, the image display device 100 can also obtain meta data for controlling an external device. The meta data can be obtained using various methods including obtaining the meta data from an internal or external server 310 as shown in FIG. 4. However, the image display device 100 may obtain the meta data using various other methods.

In addition, external server 310 may be a server operated by the production company of the media content or a server operated by a user group related to the media, for example. Thus, the image display device 100 can control various external devices based on the context information and the meta data so as to generate senses of the user or users watching the media content. For example, as shown in FIG. 4, the external devices may be the illumination device 330, an air conditioner 340, a sound device 350, or a mobile terminal 360.

In addition, the meta data may be expressed in various forms (or formats). For example, the meta data may be expressed in general text, HTML, or XML format. The meta data may also be expressed in various other formats. Further, the meta data may be decoded by the image display device 100 and include a control condition of the external device and the type and control content of the external device to be controlled.

In more detail, TABLE 1 illustrates the type of the meta data according to the first embodiment of the present application.

TABLE 1
Type of Meta Data

| | |
|---|---|
| Meta Data 1 | Context = Menu→Main Movie, Event ID = Turning |
| | off Illumination (Ext, Device Type-Illumination Device, |
| | Control Code-Turning off) |
| Meta Data 2 | Context = Main Movie→Menu, Event ID = Turning |
| | on Illumination (Ext, Device Type-Illumination Device, |
| | Control Code-Turning on) |
| Meta Data 3 | Context = 00:20:00, Event ID = Turning on 3D Glasses |
| | (Ext, Device Type-3D Glasses, Control Code-Turning on) |
| Meta Data 4 | Context = 00:25:30, Event ID = Turning off 3D Glasses |
| | (Ext, Device Type-3D Glasses, Control Code-Turning off) |

Referring to TABLE 1, in the meta data 1, the context information indicates that the main movie starts on a menu screen and the control event corresponding to the context information indicates turning off illumination (or light). In this example, the controlled external device is the illumination device and the control code is for turning off the illumination device. Since the illumination (or light) is turned off, the user of the image display device 100 can more comfortably view the media content. In addition, because the lights are turned off, the user or users watching the media content can see that the media content is starting to be reproduced.

In addition, in the meta data 2, the context information indicates that a change is made from the main movie to the menu screen and the control event Event ID corresponding to the context information is for turning on illumination. In this example, the controlled external device is the illumination device and the control code indicates turning off the illumination device. Thus, because the illumination is turned off, the user of the image display device 100 can visually sense the reproduction of the main movie is ending or stopped.

In addition, in the meta data 3, the context information indicates the time code (00:20:00) of the media and the control event Event ID corresponding to the context information is for turning on 3D glasses. In this example, the controlled external device is the 3D glasses and the control code is for turning on the 3D glasses. Thus, because the 3D glasses are turned on, the user can view the media content in 3D.

In addition, in the meta data 4, the context information indicates the time code (00:25:30) of the media content and the control event Event ID corresponding to the context information is for turning off the 3D glasses. That is, the controlled external device is the 3D glasses and the control code is turning off the 3D glasses.

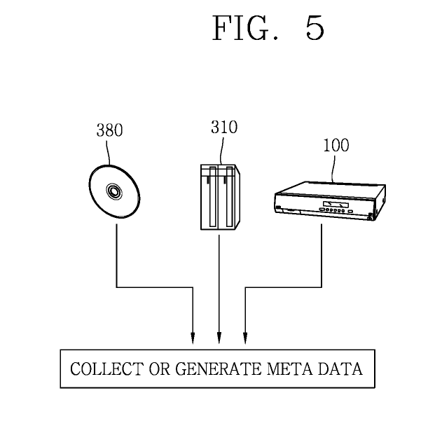

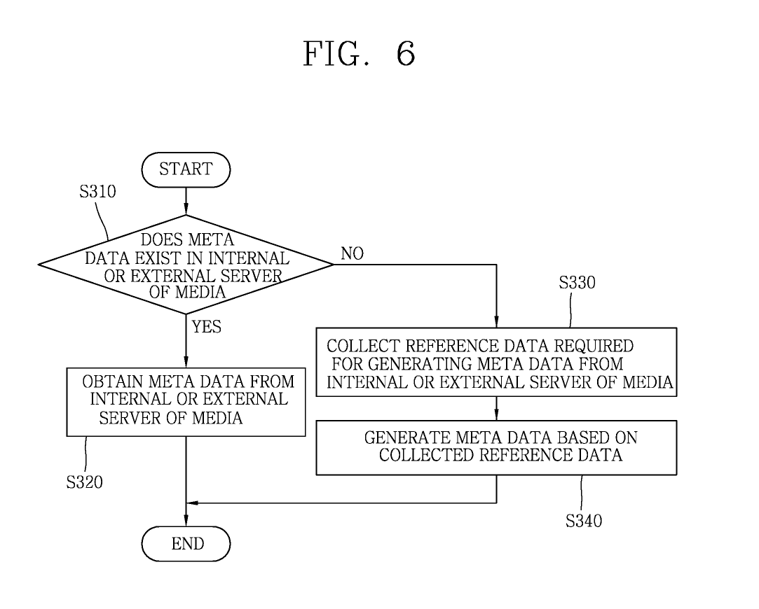

Next, FIG. 5 is an overview illustrating paths for collecting meta data according to the first embodiment disclosed in the present specification. Referring to FIG. 5, the image display device 100 can obtain the meta data from the media 380 or the external server 310 or generate the meta data by itself.

When the image display device 100 obtains the meta data from the media 380, the meta data may be produced by the production company of the media content. In addition, when the image display device 100 obtains the meta data from the external server 310, the meta data may be produced by the production company of the media content or be produced by a user group related to the media content. Further, when the image display device 100 generates the meta data by itself, the image display device 100 can generate the meta data using caption information included in the media, MPEG-7 descriptor keyword information, media chapter time information, information on chapter description on the Internet, etc.

Next, FIG. 6 is a flowchart illustrating a method of collecting or generating meta data according to the first embodiment of the present application. Referring to FIG. 6, the image display device 100 determines whether the meta data exists in the internal or external server of the media (S310). Then, when the meta data exists (Yes in S310), the image display device 100 obtains the meta data from the internal or external server of the media (S320).

In addition, when the meta data does not exist (No in S310), the image display device 100 can collect reference data required for generating the meta data from the internal or external server of the media (S330) and generate the meta data based on the collected reference data (S340). Further, the image device 100 can stop collecting or generating the meta data when the meta data is obtained from the internal or external server of the media content or the meta data is generated based on the collected reference data.

Next, FIG. 7 is an overview illustrating a method of displaying control information of an external device according to a second embodiment of the present invention. Referring to FIG. 7A, the type of media content is a movie and the user of the image display device 100 reproduces the movie through the controller (for example, a remote controller) of the image display device 100.

That is, the image display device 100 receives a remote control signal instructing the image display device 100 to reproduce the media content. The image display device 100 then determines that the media context information indicates that the reproduction of the media is started based on the control signal.

In addition, as discussed above, the image display device 100 can obtain the meta data from the internal or external server of the media. For example, when the context information indicates the media is reproduced, the meta data may include event information indicating that the illumination device is to be turned off. In this instance, the image display device 100 turns off the illumination device that is one of controllable external devices based on the context information and the meta data.

In addition, when the illumination device is turned off, the image display device 100 can display the control information of the illumination device on a screen of the display device 100 in order to inform the user of the image display device 100 that the illumination device is turned off. Thus, because the illumination device is turned off, the user of the image display device 100 can more comfortably watch the movie. The user can also advantageously sense that the reproduction of the media is started.

In the example of FIG. 7A, the image display device 100 displays a dark-colored lamp on the screen in the form of a thumbnail so as to display information indicating the illumination device is turned off. In FIG. 7B, when the reproduction of the media is stopped (for example, at the ending of the movie), the image display device 100 can automatically light the illumination device. In this instance, the image display device 100 can read context information from the media content indicating the reproduction of the media is completed.

In addition, the image display device 100 can obtain meta data including information informing that the illumination device is to be lighted when the reproduction of the media is completed from the internal or external server of the media. As shown in FIG. 7B, the image display device 100 can light the illumination device based on the context information and the meta data and display control information indicating that the illumination device is lit. For example, the image display device 100 can display a bright-colored light bulb on the screen in the form of the thumbnail.

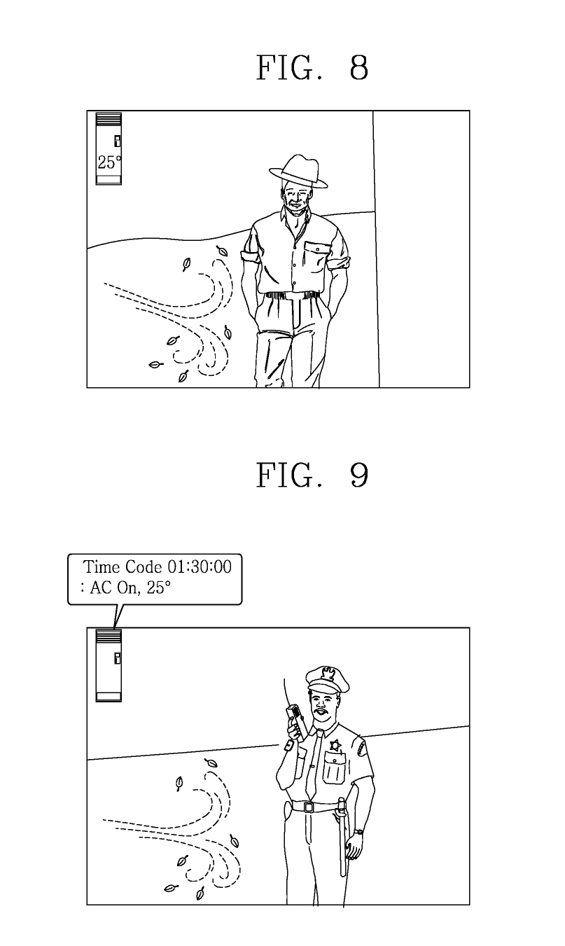

Next, FIG. 8 is an overview illustrating a method of displaying control information of an external device according to a second embodiment of the present invention. Referring to FIG. 8, the external device to be controlled is an air conditioner. In this example, the image display device 100 can obtain meta data from the internal or external server indicating that the control temperature of the air conditioner is to be set as 25° C. in a specific scene during the reproduction of the media content.

Further, the image display device 100 may read information indicating that the specific scene is being reproduced and control the air conditioner so that the control temperature of the air conditioner is 25° C. Since the temperature of the air conditioner is set as 25° C., the user of the image display device 100 can feel the air conditioner in the room and sense a blowing or cooling effect. Therefore, in FIG. 8, when a scene in which wind blows is reproduced, the image display device 100 can turn on the air conditioner and/or set the temperature to be a particular temperature so as to create a blowing and cooling effect during the scene being reproduced.

In addition, as illustrated in FIG. 8, the image display device 100 can display control information informing the user that the air conditioner is set as 25° C. as a thumbnail (e.g., an air conditioner shaped thumbnail or icon along with the control temperature on the screen).

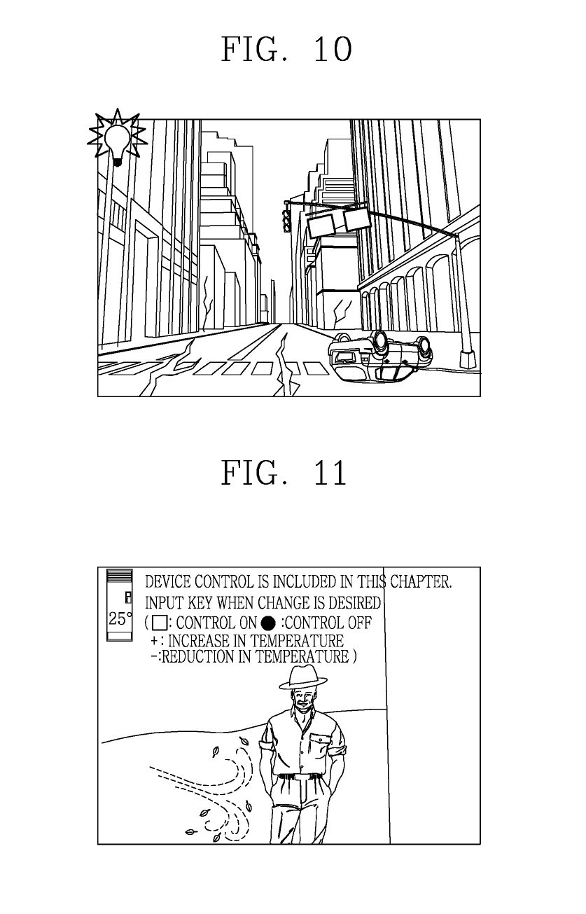

Next, FIG. 9 is an overview illustrating a method of displaying control information of an external device according to the second embodiment of the present invention. Referring to FIG. 9, the external device to be controlled is an air conditioner and the context information is the time code of the media content. In this example, the image display device 100 senses the time code from the media content and obtain meta data indicating that the control temperature of the air conditioner is to be set as 25° C. from the internal or external server.

Further, the time code of the media content is 01:30:00 (reproduction time is 1 hour and 30 minutes). The image display device 100 then sets the control temperature of the air conditioner as 25° C. based on the context information and the meta data when the time code is 01:30:00. Thus, because the temperature of the air conditioner is set as 25° C., the user watching the image display device 100 can feel cool and/or a blowing sensation. In addition, when the air conditioner is being controlled by the image display device 100, the image display device 100 can display the control information of the air conditioner as illustrated in FIG. 9.

Next, FIG. 10 is another overview illustrating a method of displaying control information of an external device according to the second embodiment disclosed in the present specification. Referring to FIG. 10, the type of media content is a movie and the reproduced scene of the movie is an earthquake.

Further, the image display device 100 obtains the meta data from the internal or external server associated with the media content. For example, when the context information indicates that the reproduced scene of the movie is the earthquake scene, the meta data may include event information indicating the illumination of the illumination device is to periodically flicker.

Therefore, when the image display device 100 retrieves the context information indicating that the scene of the movie is the earthquake scene, the image display device 100 controls the illumination device to periodically flicker based on the context information and the meta data. In addition, in the example of FIG. 10, the image display device 100 can display the control information of the illumination device (e.g., information indicating the lights are flickering). Thus, the user watching the image display device 100 can sense an emergency such as earthquake is actually occurring in the user's own home.

Next, FIG. 11 is an overview illustrating a method of displaying control information of an external device according to a third embodiment of the present invention. Referring to FIG. 11, the controller 110 prompts the user to determine if the external device should be controlled. That is, the controller 110 controls the display unit 130 to provide UI for receiving input from the user.

For example, when the controllable external device is an air conditioner, the image display device 100 can provide a UI asking the user to select whether to control the air conditioner. In the example of FIG. 11, during the reproduction of the media content, and when a specific chapter is reproduced, the image display device 100 displays control information of an air conditioner (e.g., information indicating that the control temperature of the air conditioner is set as 25° C.). The control information can be displayed as an icon or thumbnail.

As shown in FIG. 11, the image display device 100 can also display the UI asking the user to select whether to control the air conditioner. For example, the UI may include a notice “Device control is included in this chapter. When you wish a change, please input a key. (□: control on, : control off, +: increase in temperature, and −: reduction in temperature)”

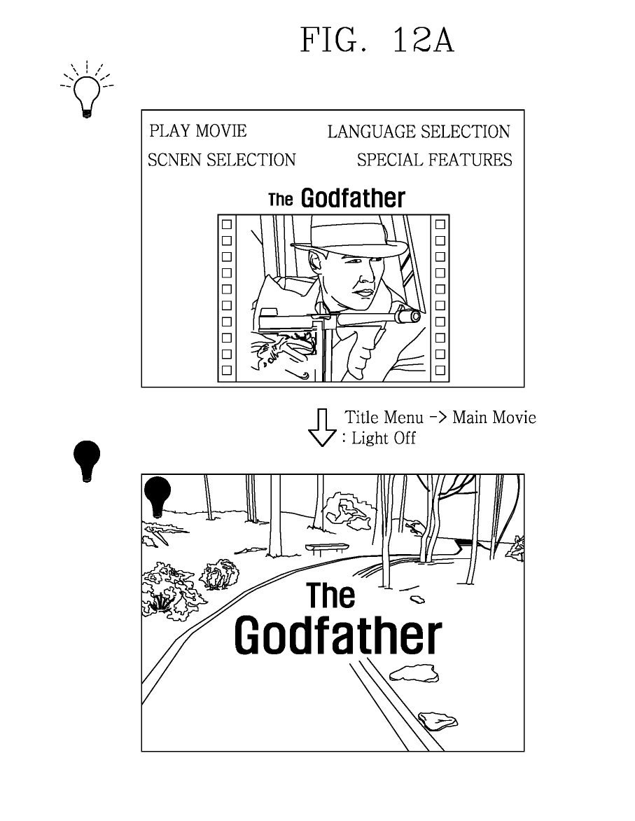

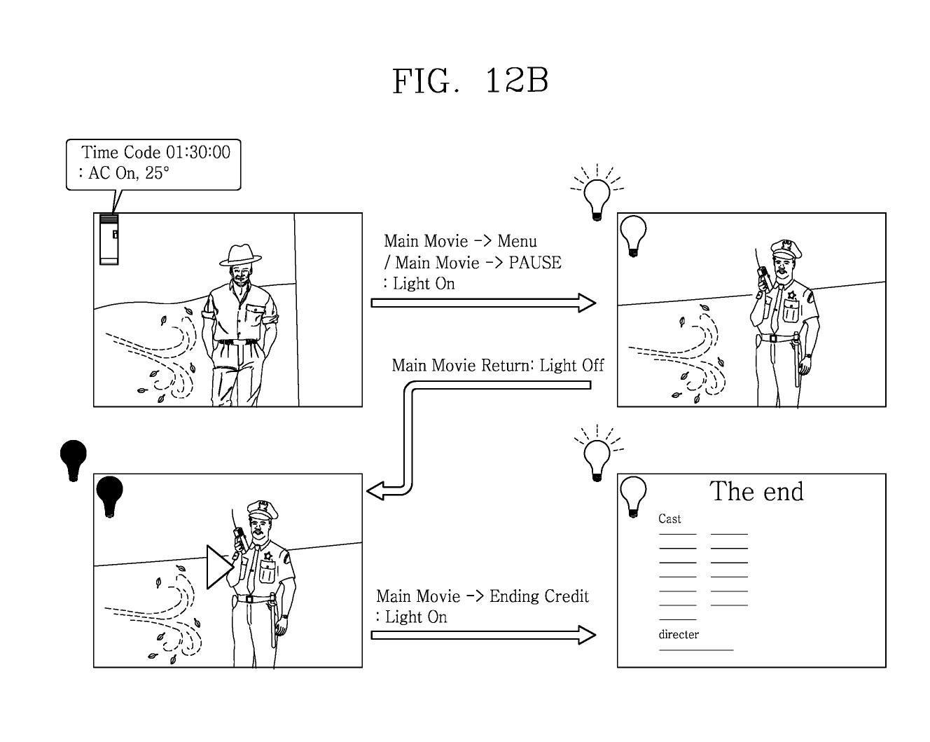

Next, FIG. 12 is an overview illustrating the control scenario of an external device according to an embodiment disclosed in the present specification. Referring to FIG. 12A, when the type of the media content is a movie, and when Main Movie is reproduced on a menu screen by the selection input of the user of the image display device 100, the image display device 100 retrieves information indicating that the Main Movie is being reproduced and can obtain meta data corresponding to the reproduction information from the internal or external server.

For example, when the Main Movie is reproduced, the meta data may include information indicating a controllable illumination device is to be turned off. In the example of FIG. 12A, when the Main Movie is reproduced, the image display device 100 turns off the illumination device. As discussed previously, because the illumination device is turned off, the user can comfortably watch the movie. In addition, the user may visually sense that the reproduction of the media is started since the illumination device is turned off. The image display device 100 display information indicating that the illumination device is turned off.

Referring to FIG. 12B, when the time code of the media is 01:30:00, the image display device 100 controls the air conditioner based on meta data indicating that the control temperature of the controllable air conditioner is to be set as 25° C. In this example, since the temperature of the air conditioner is set as 25° C., the user of the image display device 100 can feel a cooling or blowing effect. Therefore, in the example of FIG. 12B, when a scene in which wind blows is reproduced, a similar environmental effect to the content of the image can be obtained by setting the temperature of the air conditioner as 25° C.

In addition, when the user of the image display device 100 temporarily stops the movie, the image display device 100 may turn off the controllable illumination device based on the context information and the meta data corresponding to the above. Thus, the user of the image display device 100 can visually sense that the movie is stopped since the illumination device is turned on. In addition, when the user starts to reproduce the movie, the image display device 100 can turn off the controllable illumination device based on the context information and the meta data corresponding to the above.

Thus, the user of the image display device 100 can visually sense that the movie is reproduced since the illumination device is turned off. In addition, when the movie is completed, the image display device 100 can turn on the controllable illumination device based on the context information and the meta data corresponding to the above. The user of the image display device 100 can thus visually sense that the movie is completed since the illumination device is turned on.

Further, as discussed above, the external device(s) include air conditioners, lights, etc. In addition, the external devices can include devices purchased with surround sound systems. For example, the external devices can be small or large fans to blow air, water spray devices to spray mists of water, perfume devices to dispense different smells, and a variety of other devices that can affect the user's senses. Thus, the external devices may be included with a surround sound system package, be sold separately, or be completely independent devices already included in the home such as an air conditioner. The external device may also be another mobile terminal that is to ring during a particular time in the movie.

Thus, in a scary movie, for example, the phone of the person or people watching the movie may ring at the same time a phone rings in the move being reproduced. The external devices could also be portable vibrating devices that could be attached to furniture so the furniture slightly vibrates during an earthquake scene in the movie, for example.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An image display device, comprising:
a communication unit configured to wirelessly or wiredly communicate with external devices;
a display unit configured to display media content being reproduced on the image display device; and
a controller configured to distinguish at least one external device that can be controlled to generate an effect of stimulating senses of a user watching the reproduced media content, and to control the distinguished external device to generate the effect of stimulating the senses of the user in accordance with effects occurring on the displayed media content.

2. The image display device of claim 1, wherein the external device is at least one of an illuminating device, a home appliance, a mobile terminal, an image device and a sound device that exist within a same area including the image display device.

3. The image display device of claim 1, wherein the controller is further configured to control the display unit to display control information of the distinguished external device.

4. The image display device of claim 3, wherein the controller is further configured to control the display unit to display the control information as a thumbnail.

5. The image display device of claim 1, wherein the controller is further configured to retrieve context information corresponding to the reproduced media content, obtain meta data for controlling the distinguished external device, and control the distinguished external device based on the context information and the meta data.

6. The image display device of claim 5, wherein the controller is further configured to obtain the meta data from an internal or external server of the media content.

7. The image display device of claim 6, wherein the controller is further configured to determine whether the meta data exists in the internal or external server, to obtain the meta data from the internal or the external server when the meta data exists, to collect reference data used for generating the meta data from the internal or external server, and to generate the meta data based on the collected reference data when the meta data does not exist.

8. The image display device of claim 5, wherein the context information is at least one of information indicating that the reproduction of the media content is started, information on a time code of the media content, and information on an event included in the media content.

9. The image display device of claim 8, wherein the meta data comprises information on the event corresponding to the context information.

10. The image display device of claim 1, wherein the controller is further configured to determine whether to automatically control the distinguished external device or to control the distinguished external device based on an external input.

11. The image display device of claim 10, wherein the controller is further configured to control the display unit to display a user interface (UI) for receiving the external input.

12. A method of controlling an image display device, the method comprising:
allowing, via a communication unit of the image display device, wireless or wired communication with external devices;
displaying, via a display unit of the image display device, media content being reproduced on the image display device;
distinguishing, via a controller of the image display device, at least one external device that can be controlled to generate an effect of stimulating senses of a user watching the reproduced media content; and
controlling, via the controller, the distinguished external device to generate the effect of stimulating the senses of the user in accordance with effects occurring on the displayed media content.

13. The method of claim 12, wherein the external device is at least one of an illuminating device, a home appliance, a mobile terminal, an image device and a sound device that exist within a same area including the image display device.

14. The method of claim 12, further comprising:
displaying, via the display unit, control information of the distinguished external device.

15. The method of claim 14, wherein the control information is displayed as a thumbnail.

16. The method of claim 12, further comprising:
retrieving, via the controller, context information corresponding to the reproduced media content;
obtaining, via the controller, meta data for controlling the distinguished external device; and
controlling, via the controller, the distinguished external device based on the context information and the meta data.

17. The method of claim 16, wherein the meta data is obtained from an internal or external server of the media content.

18. The method of claim 17, further comprising:
determining whether the meta data exists in the internal or external server;
obtaining the meta data from the internal or the external server when the meta data exists;
collecting reference data used for generating the meta data from the internal or external server; and
generating the meta data based on the collected reference data when the meta data does not exist.

19. The method of claim 16, wherein the context information is at least one of information indicating that the reproduction of the media content is started, information on a time code of the media content, and information on an event included in the media content, and
wherein the meta data comprises information on the event corresponding to the context information.

20. The method of claim 12, further comprising:
determining whether to automatically control the distinguished external device or to control the distinguished external device based on an external input.
